(19) United States
(12) Patent Application Publication
(10) Pub. No.: US 2010/0217652 A1
(43) Pub. Date: Aug. 26, 2010

(54) System and Method for Strategic Workforce Management and Content Engineering

(75) Inventor: Linda Brooks Rix, Lakewood, WA (US)

Correspondence Address: CROWELL & MORING LLP;INTELLECTUAL PROPERTY GROUP, P.O. BOX 14300, WASHINGTON, DC, 20044-4300, US

(73) Assignee: AVUE TECHNOLOGIES CORPORATION, Washington, DC (US)

(21) Appl. No.: 12/725,813

(22) Filed: Mar. 17, 2010

Related U.S. Application Data
(63) Continuation of application No. 10/375,059, filed on Feb. 28, 2003, now abandoned.
(60) Provisional application No. 60/360,004, filed on Feb. 28, 2002.

(51) Int. Cl. G06Q 10/00; G06F 17/30

(52) U.S. Cl. 705/11; 705/321; 707/803; 707/E17.005

(57) ABSTRACT

The invention provides a system that automates workforce management tasks through the integrated use of structured content accessible from a database, a set of business logic rules engines as well as input from users via user interfaces. The invention also provides a methodology for creating engineered content which is accessible to a strategic workforce management system which manages human resources tasks.

### CROSS REFERENCE TO RELATED APPLICATIONS

This application is a continuing application of U.S. application Ser. No. 10/375,059, filed Feb. 28, 2003, which claims priority under 35 U.S.C. §119 to U.S. Provisional Patent Application No. 60/360,004, filed on Feb. 28, 2002, the disclosure of which is incorporated by reference in its entirety herein.

### BACKGROUND OF THE INVENTION

1. Field of the Invention

The invention relates to computer-based systems for workforce management and, in particular to the use of computers for improved methods of human resources management providing ongoing management of a workforce by managers and supervisors along with physical systems and methods for accomplishing these objectives.

2. Description of the Related Art

Traditionally, organizations have accomplished a wide variety of human resources and workforce management tasks and processes with an emphasis on functional silos, aggregation of authority in centralized command and control structures, and deep expertise in heavily regulated and standardized structures. More recently, largely due to labor market conditions, emphasis has been placed on disaggregating authorities to the lowest possible responsible management layer and adding transparency to the process for all participants involved. In addition, emphasis on improved productivity, in an era of shrinking domain expertise, has added a burden on existing business processes and resources at a time when increased demand is also at its peak. In the pre-Y2K period of the late 1990's, the emergence of efficiencies through data capture and centralized data warehousing led the way to client-server, relational database technologies to support the human capital function in organizations. The presence of these technologies allowed organizations, particularly large and distributed organizations, to capture, store, retrieve, and perform business analytics on data in very large data repositories. Since this period, no other material advances in the technology supporting the human resources and workforce management functions have emerged.

Computers are widely used to carry out various human resource functions as they appear in their current state. Systems are available for workflow, transaction processing, data storage, data manipulation, data modification, data reporting, generation of physical records, scanning and storage of physical records, retrieval of physical records, development of analytical reports, data processing, and data management. Systems today use a wide variety of methods to intake data, store it, process it, and retrieve it in a form that provides useful information. These systems use conventional database organization, search, retrieval, and reporting mechanisms to support various human resource and workforce management functions. Typically, these systems are not integrated and serve the exclusive purpose of supporting a single functional or business process silo. Where integrated, the integration is limited to the creation of a common database structure into which user-supplied data is stored and user-directed retrieval is possible. Integration offers a way to insure common data dictionaries or field definitions are used to avoid redundant storage of identical data elements for a single entity (e.g., social security number for an employee) by creating a common single-point repository in which data is stored once and used for multiple purposes across a spectrum of business functions and processes. This current use of computer-based systems is developed on a database model where data and databases are used to support various transaction processing, data storage, data retrieval, reporting, and business analytics functions.

In addition, current technologies are based on large, relational database architectures with application logic that permits user-directed queries to search and retrieve data, in either generic report format or, with specialized application layers, with certain analytics that are formatted at a global level. In all cases, the data within the application is provided by the user and the application logic, or queries, are engineered by the user to produce a certain retrieval form.

In addition, with regard to human resources functions, traditionally, organizations recruiting employees post employment openings in variety of publicly accessible forums, including newspapers, employment websites and on publicly viewable bulletin boards. In addition, larger organizations, such as governmental agencies, may possess dedicated resources for posting employment opportunities, such as agent websites or employment brochures. Employment solicitations generally include a brief description of the available positions and a description of the desired qualifications, such as education, experience and employment history. Interested applicants typically respond to these types of employment solicitations by submitting resumes and/or by completing job applications provided by the prospective employer.

The task of evaluating and matching applicants for employment with available opportunities typically falls upon human resources departments. This can be a time intensive process that requires matching applicant qualifications as listed in a resume or employment application against specific criteria sought by the employer. In the event that there are a large number of applicants, numerous human resources personnel may be required to carry out this matching function. Each human resources evaluator may apply their own subjective criteria when evaluating job applicants. As a result, the pool of applicants may not be evaluated in a consistent and objective manner.

This conventional technique for evaluating candidates becomes even more cumbersome for larger organizations that have many employment openings where each of the openings have many required qualifications. In addition, larger organizations or companies viewed as “premium” employers receive a high volume of resumes and/or employment applications that must be reviewed.

More recently, some of the employment solicitation and evaluation tasks described above have been implemented on-line and are accessible via a local area network (LAN) or the World Wide Web (WWW). Thus, job candidates may review employment opportunities on-line and even submit job applications or resumes for consideration on-line. Organizations can then evaluate the information received on-line. In addition, organizations can maintain databases that store employment opening information along with completed job applications and resumes. Thus, human resources personnel can search for qualified applicants by viewing job applications and resumes on-line.

### SUMMARY OF THE INVENTION

The invention provides a system that automates workforce management tasks through the integrated use of structured content accessible from a database, a set of business logic rules engines as well as input from users via user interfaces. The invention also provides a methodology for creating engineered content which is accessible to a strategic workforce management system which manages human resources tasks.

With regarding to the engineering of content, the invention utilizes everything derived from database models and provides all of the above-described functionality. The invention departs from and extends the current state of data-driven models by new and novel uses of computer-based systems and business process models that are free from the drawbacks of database-driven models. The invention, instead, provides various sources and types of content in a pre-packaged form that supports the universe of functions performed in human resources and workforce management. The content engineering process produces data which are available and utilized in a manner not found in conventional data management systems, computer applications, or in business methods or processes. In addition, the content and database structure are such that the data are available to be used, readily and without added labor, in business processes and functions not yet conceived.

The invention contains self-describing content which can be accessed in its pure form, within a relevant and applicable business process, by various rules engines unseen to the user, by a linear-sequential data relationship process, or by an inversion process that traverses conventional data relationships established by data dictionary and database-driven systems. Database relationships do not have to be derived and the process of pulling necessary content or data to complete a business process is automatically accomplished by the invention rather than by conventional queries or query tools. The invention combines user-supplied data with its self-contained engineered content to support various business processes, workflow, transaction processing, and business analytics. In addition, various rules engines exist within the invention to determine, invisibly to the user, the correct information to be displayed, the correct sequence and steps of action, and correct outputs to be accessed by the user. While vast elements of a particular business process may be tracked as required by applicable statutes and regulation, the invention does not display or require user-direction or input to complete various transactions. 80% or more of the invention's covered transactions are not visible to the user but are tracked, archived, and produced in final form to meet specific and varied regulatory, statutory, and policy requirements.

The invention also provides for communications-centric hubs in which all participants can interact and act upon a common business process. The invention automatically acknowledges user-supplied information and decisions and invisibly takes necessary steps to provide additional content where needed, complete a particular action or transaction, or inform other users of the need to engage. The invention acknowledges both a hierarchy and a network among users and insures information is shared with authorized participants in any given business process. The invention allows for user-directed participation within certain gateways based on rules engines, user authentication, and permissions granted.

The invention also provides pre-engineered business process methods with digitized content, expertly engineered to produce correct and consistent outcomes based on statutory and regulatory requirements, policy and business rules, and domain best practices.

The invention performs all functions based on a central theme which resides as a key element in the invention. The key element is then linked or connected to other elements based on the relationship of the other element to the business function being performed. The ‘key’ element may differ depending on business function so where an element may be key for Function A it may be adjunct to Function B. The invention allows an overlapping network of various business functions to rely on a common set of content and database elements. The functions are loosely connected by a domain, in this case human resource and workforce management, but may include many directories that depart from conventional definition of that domain, for example, medical or financial domain content and data. In addition, the key element of any particular business function resides in a persistent state so as to be accessed and utilized many times over for many varied purposes. For example, a key element in the compensation and position management function of the invention is the duty or activity performed in a given position. However, the key element in optimization of performance are the performance standards derived for employees based on their position (supplied by the invention) and their organization location (supplied by data derived from user-provided database like payroll systems) and designated as important by the responsible manager (supplied by the user). The key element for performance optimization is the performance standard, which is derived from the position's activities and duties as supplemented by other sources of information but is, nonetheless, distinguished from the key element of the position management function of the invention. The invention includes all key data elements in a manner which allows various elements to take precedence over others and to link to others as necessary to carry out the principal business function under the direction of the user.

The capability to engineer such content rests on the domain expertise of the content engineer and the process used to derive value from such content. This involves determining its weight and value by its semantic correlation to applicable regulatory and statutory features, or, by virtue of examining its operating value, as in, its native importance in the mission of the organization in which it may be found. It is this content engineering process which then produces a subsequent business process revolution. The content engineering process promotes the development of pre-packaged content in a manner that allows any number of business functions or domains to access and utilize that content, indeed be driven by the content, and permits casual users, as well as domain experts, to utilize the invention and perform a complete end-to-end business process for the lifecycle of that process. The invention completely displaces aspects of the business process heretofore performed manually and redistributes or eliminates conventional activities and skill-sets found supporting the human resources function.

In addition to the content engineering aspect of the invention, the invention also provides a fully integrated system and methodology for strategic workforce management allowing comprehensive planning of an organization's staffing needs. The system and method according to the invention allows users, whether they be organizations or individuals, to present employment positions in an accessible location, receive candidate information and screen those candidates to obtain a pool of candidates that meet certain pre-determined criteria.

The invention allows employers to classify employment positions using a variety descriptions, include the job title, the pay scale or pay plan, education level or even by providing specific duties and responsibilities associated with the employment position. The system in accordance with the invention may be configured to include an organization's comprehensive classification methodology, such as the Federal government's statutory based classification system.

The invention also allows employment candidates to view, on a centralized website or database, the employment position classifications generated by the employer. In response to the posted employment position classifications, applicants may apply for the positions by posting their resumes and qualifications or by completing an application provided by the employer. Further, the system in accordance with the invention is capable of generating a questionnaire customized to each employment position classification and rank applicant responses to the questionnaire using a variety of methodologies. In addition, the workforce management system in accordance with the invention is capable of generating a list of qualified candidates for a particular position in view of the generated rankings.

The recruitment system in accordance with one embodiment of the invention includes a job candidate profile database, a job position profile database and an evaluation database. The job position profile database stores a number of job position profiles including job descriptions and queries that may be posed to potential employment candidates that are based upon the desired qualifications. The job candidate profile database stores a number of job candidate profiles, which are based upon inputs by individual job candidates, including a candidate's responses to the employer's questionnaire, responses to a job application and/or resume information. The system in accordance with an embodiment of the invention then ranks the employment candidates by generating a score based upon the candidate's responses to questions. The system in accordance with an embodiment of the invention also stores the generated scores in the evaluation database and outputs a list of qualified job candidates for review.

In another embodiment of the invention, customized questionnaires associated with specific job openings are stored in an evaluation database so that when an applicant logs onto the system in order to apply for a position, the position specific questionnaire is retrieved and presented to the candidate. The job applicant can then complete the questionnaire for evaluation by the workforce module in accordance with the invention.

The invention further provides a method for managing employment recruitment that includes the steps of building at least one position profile, creating at least one applicant profile, evaluating the at least one applicant profile based upon the at least one job position profile, and outputting at least one qualified job candidate based upon the result of the evaluating step. The job position profile is constructed based on a job description and at least one of the following criteria and/or a relationship there between: duties, job classifications, compensation levels, performance issues, employee development activities, training and recruitment and staffing criteria. The step of creating the at least one applicant profile includes receiving job application information from at least one applicant. The method further includes a step of creating at least one questionnaire for the at least one position profile and the questionnaire is created based upon at least one position criteria. When applying for a specific job position, the applicant fills out the questionnaire and sends the filled-out questionnaire to a computer system to be evaluated, scored and ranked by the evaluation step.

In addition, where many conventional systems utilized the Internet (Web), this invention exceeds the typical information posting and data exchange of current Web-based systems. The invention is, in fact, a fully functioning application which accesses a complete, self-contained, digital human resource and workforce management service via the Web.

The invention also allows for all of the functionalities described herein to be stored on various types of electronic media.

Additional features and advantages of the invention will be set forth in the description that follows, and in part will be apparent from the description, or may be learned by practice of the invention. The objectives and other advantages of the invention will be realized and attained by the structure particularly pointed out in the written description and claims hereof as well as the appended drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 illustrates the interface, application and content database layers in accordance with an embodiment of the invention;

FIG. 2 shows a representation of database relationships, arrays and hierarchies in view of content engineering in accordance with an embodiment of the invention;

FIG. 3 illustrates a process for content engineering in accordance with an embodiment of the invention;

FIG. 4 shows a continuous validation and automatic recalibration process in accordance with an embodiment of the invention;

FIG. 5 is a chart illustrating functionalities associated with a strategic human resources management system in accordance with an embodiment of the invention;

FIG. 6 show a strategic workforce analysis system in accordance with an embodiment of the invention;

FIG. 7 illustrates rules engines associated with the strategic workforce analysis system of FIG. 6;

FIG. 8 shows a process illustrating the operation of rules engines in accordance with an embodiment of the invention;

FIG. 9 shows a block diagram of the classification and staffing system in accordance with an embodiment of the invention;

FIG. 10 is a flow diagram showing the process steps for creating a job position classification in accordance with an embodiment of the invention;

FIG. 11 is a flow diagram showing the staffing process in accordance with an embodiment of the invention;

FIG. 12 is a flow diagram showing the job application process in accordance with an embodiment of the invention; and

FIG. 13 is a flow diagram showing the job recruitment process in accordance with an embodiment of the invention.

### DETAILED DESCRIPTION OF THE PREFERRED EMBODIMENTS

Reference will now be made in detail to the preferred embodiments of the invention, examples of which are illustrated in the drawings.

The invention as described in greater detail below provides system and methods that automate workforce management tasks through the integrated use of a structured content accessible from a database, a set of business logic rules engines as well as input from user's via user interfaces. The system in accordance with the invention enables non-professional users to conduct various workforce management activities in a manner that meets all applicable legal, regulatory and organizational requirements.

In addition, the invention also provides a process for the capture, analysis, structuring, marking, data design, data engineering, and data entry which utilizes a method of analyzing domain-specific and domain-related content so that it may be used for multiple purposes and support many different business processes.

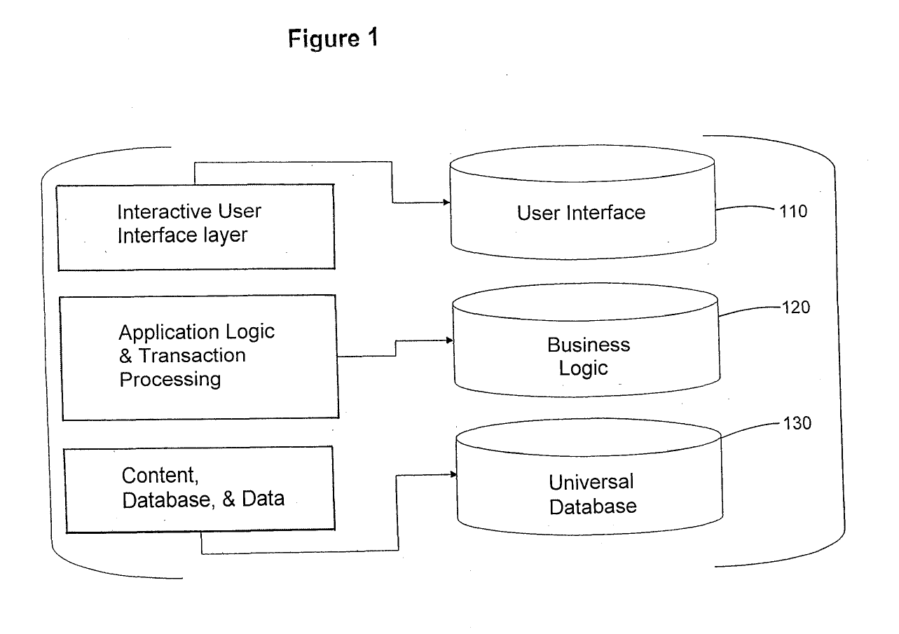

Thus, the invention can be described in conjunction with FIG. 1, which shows three tiers, a user interface tier 110, a business logic tier 120 and a database tier 130. The user interface tier 110, which is described in greater detail below, is the interactive layer that allows a user to access the functionality in accordance with the invention. The application logic, as well as the array of functionalities provided in accordance with the invention resides in the business logic tier 120. The actual content databases which drive the functionality reside in the database tier 130.

Returning to the user interface tier 110, the user interface tier 110 is also the location where certain roles and permissions are embedded along with markers and pointers that allow users access to certain views. These views depend upon a user's role within an organization. Thus, for example, a manager within an organization may have a certain role or permission that allows them to view certain information in a certain format via his or her user interface. Therefore, the user interface tier 110 includes functionality which creates customized views for various users. The user interface tier provides functionality which identifies a user's roles and permissions, creates pointers and markers within the content database based upon the user's roles and permissions and then presents a customized view to the user.

The database tier 130 in accordance with the invention allows linking data sets in multiple arrays which are then, subsequently, called using a series of pointers based on the use of the data, its hierarchy within a given business process, its individual attributes, and its relationship to other data covered by that business process. The invention provides for the development of these pointers, relationships during the content engineering process as well as methods of developing content and establishing the behavior and attributes of that content within a specific domain. As referred to herein, a domain may refer to field of study, activity or interest or function in which there resides a central theme. As used herein in the context of human resources processes, various business functions (i.e., human resources, workforce management, human capital management) are the domains. Content refers to the matter dealt with in the field of study, such as the body of written work, events, physical detail and other forms of information. Content analysis as used herein refers to the analysis of the manifest and latent content of a body of communicated material through the classification, tabulation, and evaluation of its key symbols and themes in order to ascertain its meaning and probable effect.

The data design in accordance with the invention allows for an endless set of source data relationships and complete flexibility as to the hierarchy of any data element in relation to others based on the business process performed by a user. That is, the data relationships are defined by the business process and any data set can hold the ‘key’ or ‘root’ position in the hierarchy and have any number of subordinate, linked data sets which then comprise that hierarchy.

The data array in accordance with the invention traverses traditional business process silos or functional lines and thereby permits novel and aggressive reengineering of various processes conventionally found in the human resources and workforce management fields. Because of conditions found in the labor market, the current state of management art, the newly discovered capabilities of Web technologies, and continuing litigation trends in the human resources and workforce management domains, the introduction of new designs as to how these domains are supported by technologies must be both successful and, simultaneously provide significant demonstrated returns on investments. The invention provides such returns in numerous ways. The invention will be described in terms of how, by virtue of the content engineering methods employed, it can provide reengineered business processes which eliminate 80% or more of the labor associated with the process and do so off-the-shelf, bypassing lengthy customization, application functionality development, data entry, and deployment required by conventional systems today. This is largely accomplished by the invention's focus on the holistic nature of a business process. The invention pre-packages all the required elements of data and content and organizes it in a manner which allows occasional, non-expert, users to access and complete business processes and transactions without specialized training, application or database customization, or special deployment efforts. Users (subscribers) to the invention are capable of operating it within minutes of acquiring a subscription.

The invention insures that applicable statutes, regulations, policies, and domain best practices are fully addressed in the manner in which the content is engineered and referenced. The invention, thereby, encapsulates these requirements and, in doing so, manages the risk for non-expert users by shielding them from making inadvertent errors, errors of omission, procedural errors, and other mistakes that might result in regulatory or statutory violations, breaches of governing policy, or activities which are sub-optimal for the conditions present. In addition, the invention deliberately protects the organization from individuals who may intentionally commit acts which violate these provisions and pose litigation risk for the organization.

The invention also provides for a content ‘self-learning’ process by which the system solicits feedback from users, in a specified form, and then transmits that feedback into the invention's process for revising, updating, modifying, adding, or otherwise adjusting the data visible to users. The process allows continuous development, a particularly significant asset when new or emerging market conditions or workforce management trends occur.

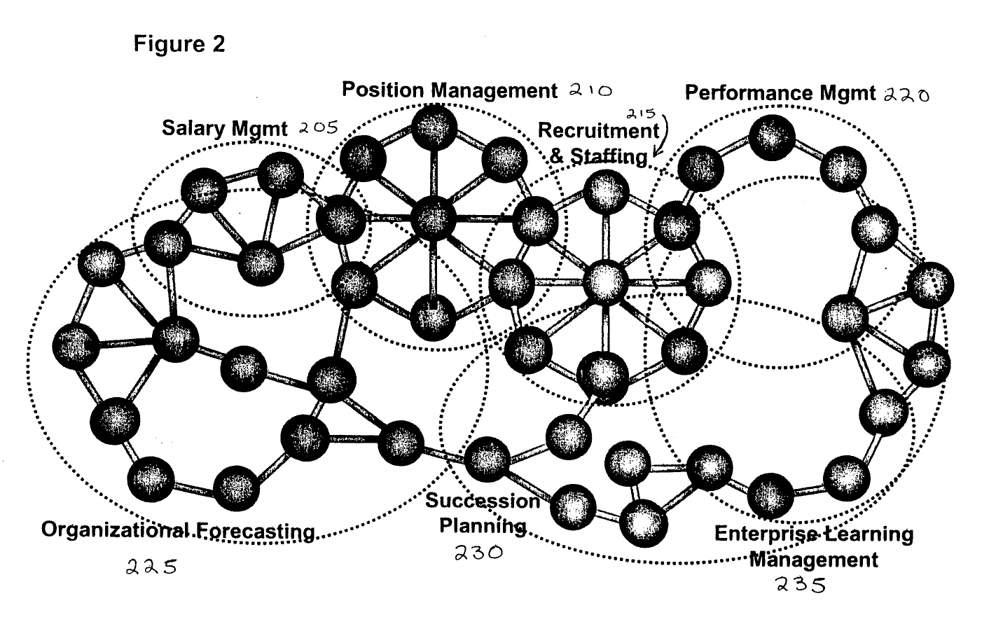

FIG. 2 illustrates a representation of the database relationships, arrays and hierarchy in view of content engineering as described above. FIG. 2 shows the following arrays, a salary management array 205, a position management array 210, a recruitment and staffing array 215, a performance management array 220, an organizational forecasting array 225, a succession planning array 230 and an enterprise learning management array 235. Each of these arrays is a data array which is equal to the subject-matter or business function within a workforce module, as will be described in greater detail below, and each data array includes a series of independent data sets. For example, a data array for the classification function which will be described in greater detail below would include data sets of duties, skills, grade, and occupational series, etc. In FIG. 2, these are displayed as dotted lines around a series of dots or circles. Also, in FIG. 2 the data sets are the dots or circles which contain data of a specific form or type, e.g., job duties are one data set, job skills are another data set. In FIG. 2, the database relationships, pointers, markers and links are displayed as lines joining various data sets to one another. These are examples of the persistent database relationships described below. Thus, FIG. 2 serves to illustrate the interaction between the data arrays.

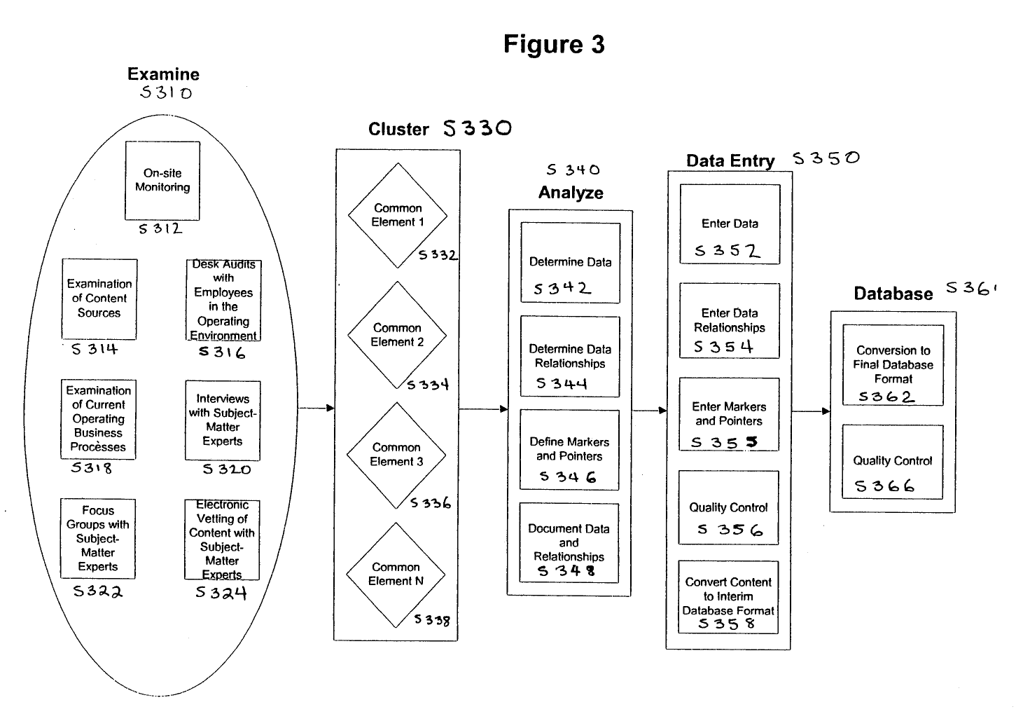

FIG. 3 illustrates a process for content engineering in accordance with an embodiment of the invention. In FIG. 3, the process begins in step S310 where an examination of a variety of sources of content and the current operating business processes involved is conducted. A shown in FIG. 3, a variety of factors may be examined in this step, including on-site monitoring S312, examination of content sources S314, desk audits with employees in the operating environment S316, an examination of current operating business processes S318, interviews with subject matter experts S320, focus groups with subject matter experts S322 and electronic vetting of content with subject matter experts S324. Thus, in the human resources context and in accordance with embodiments of the invention, the examination of step S310 may include review of historical documents; applicable regulations, guidance, statutes, policies, case law, and established standards; industry best practices; public sources of information (such as US Bureau of Labor Statistics, US Equal Employment Opportunity Commission, US Office of Personnel Management records and data, etc.); and prior works within the system itself. Following the examination step S310, the process then moves to step S330.

In step S330, having completed the examination, the universe of information is then arrayed in a series of ‘clusters’ which represent a body of content and data which has a common base, however diverse the content may be within that body. Clusters are then established by examining the operating environment of various organizations in which the body of content is used in order to determine, by examining these day-to-day mission-critical operations, how the content can be organized from a point of perspective most closely matching the perspective from which it will be viewed and understood by the individual user. This departs from how the information might be organized in existing regulation, or other similar guidance or governmental standard. For example, where the US Office of Personnel Management might organize Patent Attorneys in a grouping of other patent and trademark related occupations, this invention, by organizing the content into clusters of occupations according to mission operations, might blend work in other groups such as engineering, information technology, operations research, bench science, and other job families in a way that more directly supports the mission of the agency. This eliminates the need for the non-HR user to know the various coding structures and occupational groupings and divisions to find the content necessary to carry out the business process desired.

Clusters emerge based on the density of certain factors which appear to be common across a body and which is determined during the examination phase. Clusters of occupations may form based on a common set of skills or competencies required, a common job grading methodology, a shared set of activities that cross various occupational disciplines, a shared career path, or other similar variable. These clusters allow for the establishment of a data set array and also provide ease of use when non-expert users enter the system to accomplish a task without the benefit of years of research, background, training, or subject-matter specific domain expertise. The clusters are original and derived by virtue of this examination process and not by pre-established guidelines, regulations, or other commonly available works. Thus, as shown in FIG. 3, the clusters may be grouped as a common element-1 332, a common element-2 334 common element-3 336 and a common element-N 338. Once the clusters are created, the process moves to step S340.

In step S340, once the clusters are established, the process of performing analysis of that cluster to produce the engineered content is then conducted. This analysis, referred to as multi-purpose job analysis, is a method by which all data and all relationships are determined and then documented and entered into a database structure with a single process. The multi-purpose job analysis (MPJA) is a one-time global job analysis process which eliminates the need to perform individual job analysis for each process or step within the process, as is typical for an organizations that do not use the invention. For example, in accordance with embodiments of the invention, job duties are analyzed using this process and are correlated to skills and performance criteria. This eliminates the need to analyze and link duties to skills at a separate point or step in the business process and then again in the performance management process. With this invention, many iterations of job analysis to support the total human resources process are eliminated. The data can then be invoked, analyzed, displayed, configured, and compiled to produce certain results based on the business process involved. The multi-purpose job analysis is the function which provides the invention with its endless set of source data relationships and flexibility as to the hierarchy of any data element in relation to others based on the business process performed. It is at this point that the series of pointers is defined and the use of the data, its hierarchy within a given business process, its individual attributes, and its relationship to other data covered by that business process are all determined.

Thus, as shown in FIG. 3, the step S340 of performing analysis of each cluster to produce the engineered content includes the step S342 of determining the data, the step S344 of determining the data relationships, the step S346 of defining markers and pointers and the step S348 of documenting the data and relationships. The process then moves to step S350.

In step S350, data entry occurs. Data entry refers to the specific sequencing and formatting of the content data that was engineered in steps S310, S330 and S340. The data entry step S350 includes the steps of entering the engineered content data in step S352, entering the relationships between the data in step S354, entering markers and pointers in step S355, conducting a quality control operation in step S356 and then the engineered content is converted to an interim database format in step S358. The process then moves to step S360.

In step S360, the engineered content is merged into a content database. Step S360 may further include the step S362 of converting the engineered content from an interim database format to a final database format. Then, in step S366, a final quality control step is conducted.

The invention structures such content so that these pointers, attributes, and relationships are persistent, even when the data set is inverted or used to traverse across various functions where the ‘key’ or ‘root’ position in the data hierarchy may flip, precede, or succeed other data in the array, and, at any given time have any number of subordinate, linked data sets which comprise real-time adjustments to the hierarchy. This persistence allows for continuous validation of the data relationships and permits users to adjust the properties of a business transaction or process in real-time while the system then responds with automatic re-calibration of the outputs or results. Thus, in the event that any data is changed, for example, in the human resources context, if a job duty description is changed, then through this continuous validation process, all of the data content is adjusted (i.e., recalibrated across the entire system).

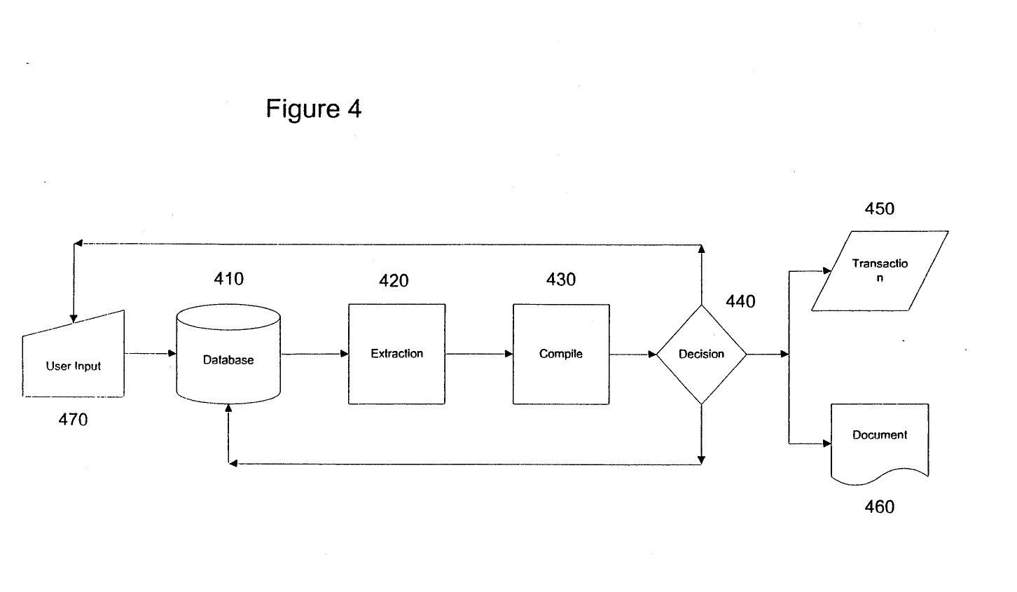

FIG. 4 illustrates the continuous validation and automatic recalibration process in accordance with an embodiment of the invention. In FIG. 4, content resides in the database 410 based upon user input 470 input by a user. The content is then extracted during an extraction process 420 and then is compiled during a compiling process 430. In the next step 440, a decision is made as validity of the content (i.e., content validation). This determination is based upon whether the data meets certain regulatory, statutory or other requirements. If the content does meet these requirements, the content is passes through to transaction step 460 and is documented at step 470. If the content is not validated in step 440, the system provides a re-calibration instruction to the content database 410 and to the user input 470. In this iterative manner, the data relationships are continuously validated.

This persistence, a direct output of the clustering and multi-purpose job analysis methodology, provides the invisible structure and features that permit adherence to the regulatory, statutory, and other requirements. In addition, it provides an audit trail for the defense of organizations should litigation or other grievance or appeal processes challenge decisions taken by particular users or their organizations. The invention also takes key aspects of business process logic and embeds this into the content itself so as to further ensure sustainable defenses in litigation or grievance processes and to further reduce the risk of non-expert users committing inadvertent errors. Typically, this invention is used in domain areas where the regulation is substantial and the output highly visible so the use of embedded process logic is critical to a sustainable, worry-free outcome. As the human resources and workforce management domain disaggregates on an increasing level, the need for this increases. This embedded process logic, or ‘smart content’, is also defined at the time the content engineering process is performed. Such smart content might include, for example, key words or phrases which are marked to be read-only to keep users from editing such phrases and thereby losing the validation to a specific compensation level or value. Smart content may also be marked to substitute certain words or phrases with others based on the user's role in the organization and employing organization or sub-entity.

In addition to the content engineering embodied in the invention, the invention also uses key ‘rules engines’ to determine what type of output should be produced given a certain input. These engines are based upon specific regulatory and statutory provisions as well as policies, best practices, and case law. The engines are developed as an overlay to the content database and are mapped to user selections or choices; specific steps within a business process; user supplied information; specific dates or milestones; or similar trigger points. The rules engines are unique in that they do not exist, outside of this invention, in digital form and are an advance, made possible by the computational power of technology, over the process used by humans when performing these functions in manual operations. The rules engines are in specific sets and described in greater detail below in conjunction with the strategic workforce management system in accordance with the invention.

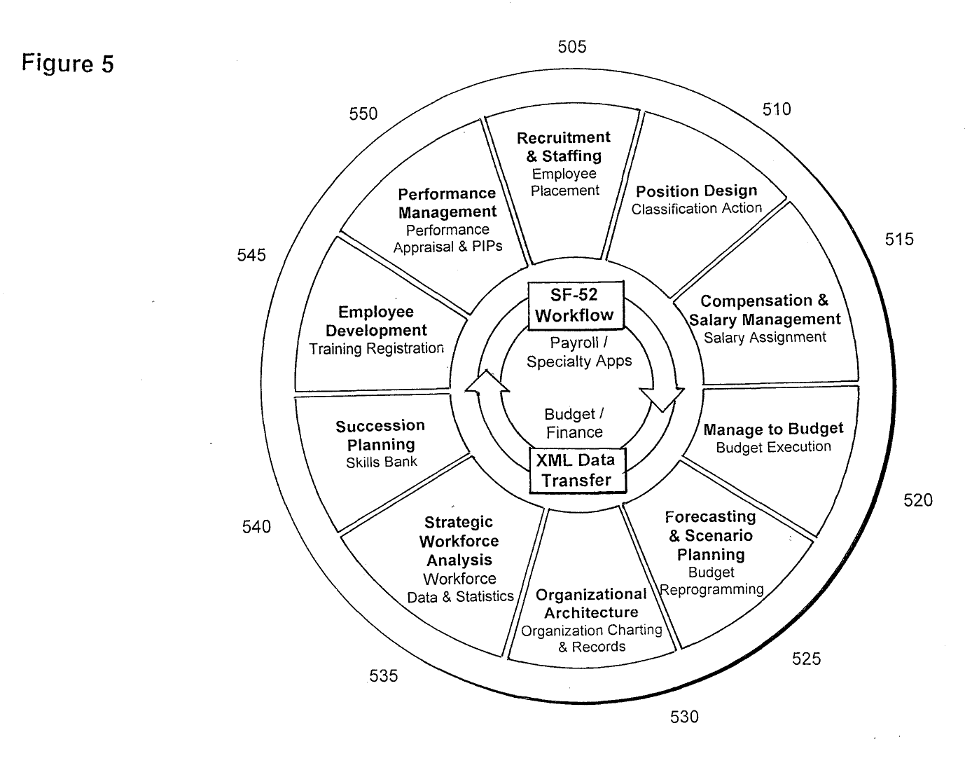

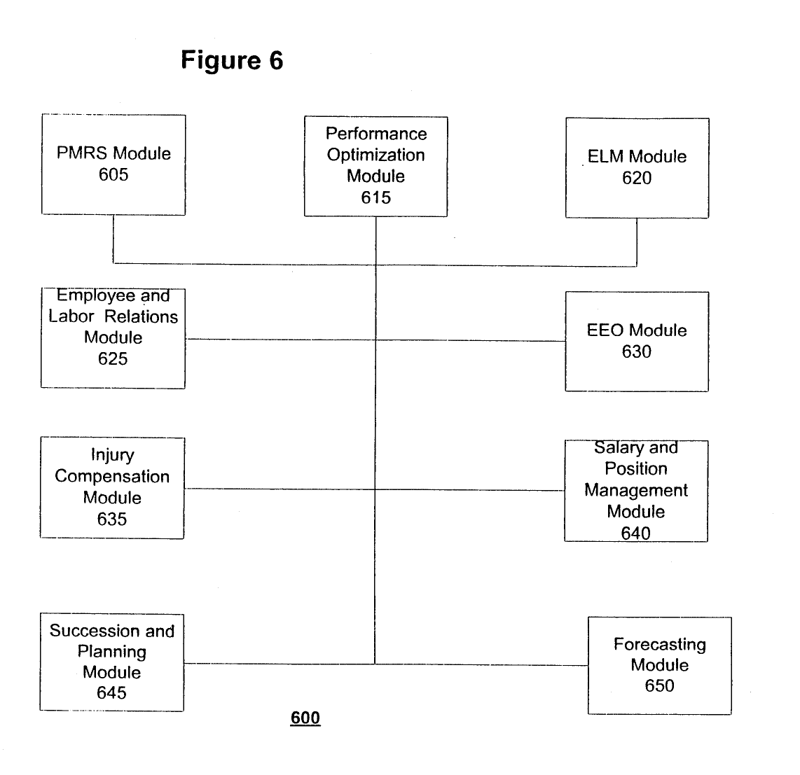

FIG. 5 illustrates the functionalities associated with a strategic workforce management system (which is shown in FIG. 6) in accordance with an embodiment of the invention. It is important note that the content engineering process described above provides the engineered data content that is accessed by the strategic workforce management system. The strategic workforce management system in accordance with the invention provides a solution which includes all of the content databases, expert system rules engines, application functionalities and information technology (IT) infrastructure needed to perform all of the functional areas of human resource administration and human capital management.

As shown in FIG. 5, the strategic workforce management system in accordance with the invention includes the following functionalities, a Recruitment and Staffing functionality 505, a Position Design functionality 510, a Compensation and Salary Management functionality 515, a Manage to Budget functionality 520, a Forecasting & Scenario Planning functionality 525, an Organizational Architecture functionality 530, a Strategic Workforce Analysis functionality 535, a Succession Planning functionality 540, an Employee Development functionality 545 and a Performance Management functionality 550. The strategic workforce management system also includes a Payroll/Specialty Applications functionality 555 and a Budget and Finance functionality 560. The Recruitment and Staffing functionality 505, the Position Design functionality 510, the Compensation and Salary Management functionality 515, the Employee Development functionality 545, the Performance Management functionality 550 and the Payroll/Specialty Application functionality 555 are all considered to be traditional human resources functions. The Manage to Budget functionality 520, the Forecasting & Scenario Planning functionality 525, the Organizational Architecture functionality 530, the Strategic Workforce Analysis functionality 535, the Succession Planning functionality 540, the Employee Development functionality 545 and the Budget and Finance functionality 560 are all management planning functions. Each of the functionalities described above will be described in view of the strategic workforce management system.

FIG. 6 shows the strategic workforce management system 600 in accordance with an embodiment of the invention. The strategic workforce management system 600 carries out each of the functionalities described above. As shown in FIG. 6, the strategic workforce management system includes a series of functional modules including a series of modules which address all forms of personnel, human resources and human capital management processes from transaction processing to strategic planning. As described in greater detail below, the strategic workforce management system 600 combines engineered content with application functionality in an expert system to produce documents, decisions, advice, reports and data feeds in a fully hosted extranet environment. The strategic workforce management system 600 allows management of entire human resources operations within a single integrated system. It also provides communications-centric hubs for collaborative business processes.

As shown in FIG. 6, the strategic workforce management system includes the following modules: a Position Management, Recruitment and Staffing (PMRS) module 605, a Performance Optimization module (POM) 615, an Enterprise Learning Management (ELM) module 620, an Employee and Labor Relations module 625, an Equal Employment Opportunity (EEO) module 630, an Injury Compensation module 635, a Salary and Position Management module 640, a Succession Planning module 645 and a Forecasting module 650.

Before describing each if the modules associated with the strategic workforce management system 600 in greater detail, certain rules engines associated with the strategic workforce management system 600 are described.

The strategic workforce management system 600 provides a number of rules engines tied to specific regulatory and statutory provisions as well as policies, best practices and case law. These rules engines provide strategic decisioning throughout the strategic workforce management system 600.

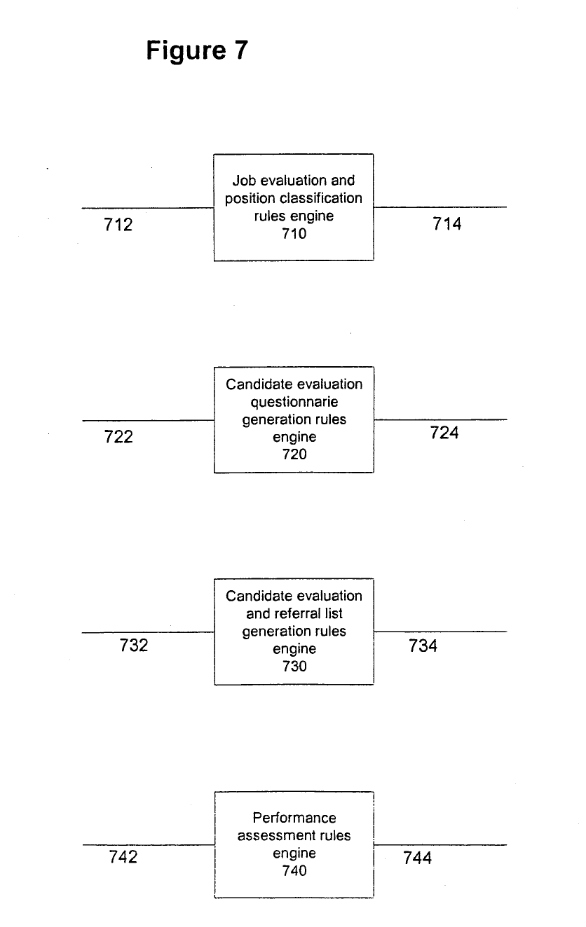

As shown in FIG. 7, the rules engines include a job evaluation and position classification rules engine 710, a candidate evaluation questionnaire generation rules engine 720, a candidate evaluation and referral list generation rules engine 730 and a strategic plan integration into performance assessment rules engine 740.

With regard to the job evaluation and position classification rules engine 710, system 600 (shown in FIG. 6) uses over 480 published occupationally-specific standards and 20 functional guides (e.g., for supervisory jobs of all types) to grade positions in several hundred occupational codes or classes. Each position, which may be completely unique from any other position ever created using the invention, is compared against certain factors which are defined at the time of the multi-purpose job analysis process. These factors are then compiled with other user-supplied data, for example the frequency of a particular job activity, and are applied to the job evaluation and position classification rules engine 710 as input 712. The job evaluation and position classification rules engine 710 then outputs the correct job classification 714, for a unique position, in real-time. Whereas the manual process involves a laborious and extensive amount of time reading and comparing words in position descriptions to words in the published standards and guides, the job evaluation and position classification rules engine 710 derives the correct classification. The result is that what takes hours of labor and weeks in cycle time to complete is performed in seconds. The operation of the job evaluation and position classification rules engine 710 varies based on the type of position, the nature of the regulatory guidance provided, the data used in the analysis, and the organizational context or location of the position. The job evaluation and position classification rules engine 710 is adjusted, from time to time, to reflect the issuance of new guidance and precedent-setting case law.

FIG. 7 also shows the candidate evaluation questionnaire generation rules engine 720. The system 600 produces a series of questions designed to evaluate the basic eligibility and qualifications as well as rank order the qualitative experience of individuals applying for positions on the basis of a wide variety of factors, each driven by the organization for which the recruiting and placement effort is conducted. An applicant's responses to the questions are then input 722 into the candidate evaluation questionnaire generation rules engine 720, then constructed in real-time into a questionnaire when a user directs it to recruit for a position and applies the rules found, for example, in the Uniform Guidelines on Employee Selection Procedures and the Merit System Principles and Prohibited Personnel Practices. The questionnaire is custom-generated for each position's unique duty structure and job classification. The questionnaire may take into account user supplied data, including modifying or editing invention-supplied information, or user input in the way of numerically valuing certain questions or arranging for multipliers to be applied at the time the applicant responds to the questionnaire. The candidate evaluation questionnaire generation rules engine 720 then applies various regulatory and policy provisions, often unique to the user's organization, to construct the questionnaire. The candidate evaluation questionnaire generation rules engine 720 determines, for each employing organization, the correct set of rules and variables that drive the structure and content of the questionnaire. The rules support various forms of the applicant assessment business process including assessment methods, inputs that are required versus optional as requested from applicants, use of minimum qualification requirements, the validation requirements for experience evaluated for applicant ranking, and the questions used to derive the eligibility of the applicant for consideration. The engines are often driven from domain standards, court-ordered processes, internal employing organization policies, and union negotiated agreements. Thus, the output 724 of the candidate evaluation questionnaire generation rules engine 720 is a questionnaire.

FIG. 7 also shows the Candidate Evaluation and Referral List Generation rules engine 730. The Candidate Evaluation and Referral List Generation rules engine 730 also applies various digitized rules to create the referral list of the ‘best qualified’ candidates for consideration by hiring officials. The Candidate Evaluation and Referral List Generation rules engine 730 applies various rules provided within Title V of the United States Code, the Veterans Preference Act, the Veterans Equal Opportunity Act, the Veterans Readjustment Act, various Executive Orders, the US Office of Personnel Management Handbook for Delegated Examining Units, prevailing case law, court enforced settlement agreements, interagency agreements, employing organization internal promotion policies, union agreements, and industry best practices.

The Candidate Evaluation and Referral List Generation rules engine 730 takes applicant responses to various question sets derived by the Candidate Evaluation Questionnaire Generation rules engine 720 and then constructs a list of the best or highly qualified candidates, among them the ranking of applicants either by numerical value or other method of qualitatively valuing the candidate's experience. The system 600 applies various forms of ‘list locking’ to prevent hiring managers from breaching regulatory requirements by forcing the hiring manager to consider and offer employment only to those applicants within the permissible range offered by the rules set. As hiring managers make selections, receive declinations, or find candidates are no longer available for hire, the system 600 offers revised lists, again within the permissible range of the rules set, and the hiring manager may continue with placement actions.

FIG. 7 also shows the Strategic Plan Integration into Performance Assessment rules engine 740. The Strategic Plan Integration into Performance Assessment rules engine 740 couples user-supplied information with employing entity strategic plans to develop a hierarchy that allows organizations to take strategic goals and cascade them down to the lowest possible organization level. The invention insures that every individual employee within an organization is provided a performance plan that aligns the individual performance plan with the organization's strategic plan and permits the organization to track, monitor, manage, re-direct, and report on performance in accordance with the Government Performance and Results Act. The engine calculates the amount of human capital devoted to a particular strategic plan goal, on an enterprise wide basis, and permits very accurate reporting of the achievement of goals, from individual up to the enterprise. The Strategic Plan Integration into Performance Assessment rules engine 740 also provides expert, decision support so that the enterprise may balance the resources required to achieve certain goals against a framework that helps define the extent to which the goals are valued or important to the organization's oversight bodies. The valuation of the goals allows managers to ‘load balance’ from among competing resources and also provides the opportunity to distinguish from among various competing priorities for resources. The Strategic Plan Integration into Performance Assessment rules engine 740 also guides managers, using a decision support assessment engine, with regard to compensation adjustments based on performance achievements of individual employees as compared to each other and as compared to the similarly situated workforce in the enterprise. The invention also tracks the value of performance-based compensation to assist individual managers with budget tracking and compensation tracking features.

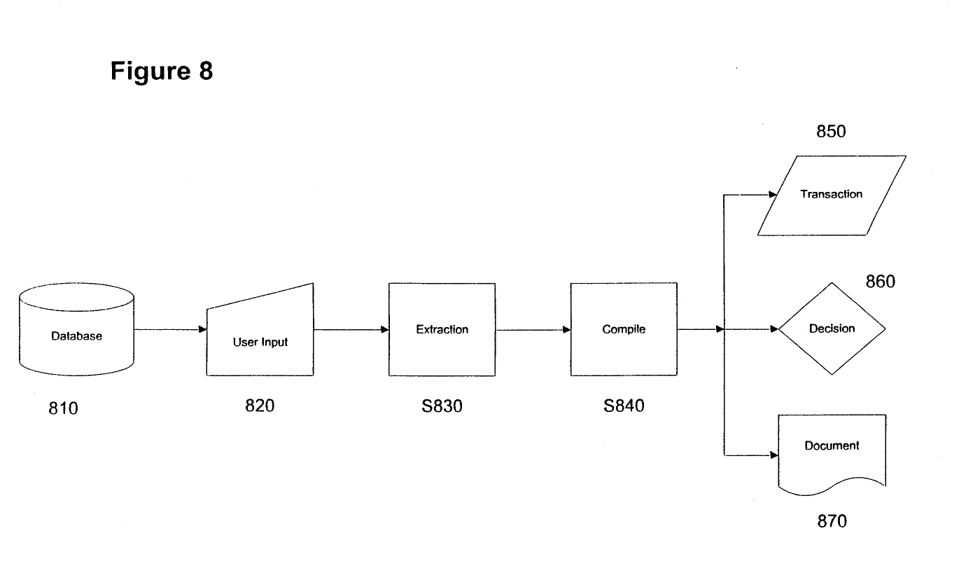

FIG. 8 shows a general process that is applicable to all of the rules engines 710, 720, 730 and 740 described herein. FIG. 8 shows a database 810 which includes the engineered content, engineered in accordance with the invention. User input 820 is then received reflecting functionality to be performed in view of the input 820. The system then conducts and extraction step S830 and a compiling step S840. The extraction and compiling steps S830 and 5840 constitute the rules engines in accordance with the invention. Output from the rules engines is then delivered to a transaction component 850, a decision component 860 and a document component 870.

Returning to FIG. 6, each of the functional modules of the strategic workforce management system 600 will be described in turn.

The PMRS module 605 supports three major human resources (HR) activities, position management, recruitment and staffing. The position management activities include job evaluation, job analysis, classification, pay, performance plan development and competency development. In accordance with the invention, these processes are automated, including the processes for creating classified positions and providing key documentation related to a position. The system also analyzes a position to determine all relationships between duties, job classification, compensation level, performance standards, employee development activities and training. All of the documents are integrated and correlate back to critical job activities. In the event that positions are edited, the classification analysis and documents generated are recalibrated.

Once a position is established, the PMRS module 605 simultaneously builds a custom job application based upon the specific requirements of the position. This application may be completed on-line and then submitted for ranking and rating.

The PMRS module 605 also provides position information which can be accessed seamlessly for recruiting and staffing. The PMRS module 605 provides electronic recruiting, job posting, application questionnaire positing, applicant intake, rating, ranking and referral of applicants. When a position is approved, it is posted to a number of recruitment sites simultaneously. The PMRS module 605 also allows users to tailor a recruitment action to a specific site or series of sites.

The PMRS module 605 also allows applicants to define their interests using a number of variables including salary, geographic location, organization, title, job category, etc. The processes associated with the PMRS module 605 are described in greater detail below.

The PMRS module 605 is also associated with classification functionality. The classification functionality will be described in greater detail below, but in general includes a classification for all of the employment positions that are available in the strategic workforce management system 600. Each employment position may be classified in accordance with a particular organization's guidelines. In the case of government agencies, the employment positions may be classified based upon Federal statues and guidelines (e.g., Title V, Classification Act of 1949). For example, employment positions may be classified based upon a job title, a job category, a pay plan or a grade. In addition, and as will be described in greater detail below, each employment position may have associated duties and responsibilities. These duties and responsibilities may be specific to each employment position and are based upon various duties and/or responsibilities that candidates for a particular employment position may possess. For example, for the job position of computer programmer, the associated duties and responsibilities may include the ability to program in C.sup.++ computer language. The duties and responsibilities for each employment position may be based upon an organization's guidelines or Federal government guidelines in the case of Federal government employment positions, and may be continually revised over time as an employer's needs change. By selecting duties and responsibilities that are desired for a particular employment position, an employer may refine the position description beyond a simple job title.

Thus, the classification functionality provides numerous features, including the creation and classification of employment opportunities, provides key documentation related to employment positions, analyzes a position and determines likely relationships between duties, job classification, compensation level, performance issues, employment development activities, training and the recruitment and staffing criteria necessary to evaluate candidates for positions. The classification functionality may also produce a classification description, an evaluation statement, a vacancy announcement, a crediting plan, a performance plan and an interview guide. These documents may be fully integrated.

The PMRS module 605 also provides a functionality that allows job applicants to check on the status of employment positions that they may have applied for. This functionality employs a communications hub to update all participants in a particular business process or transaction by forwarding notifications, updating status logs, updating personal portals created by users and triggering e-mail notifications to prompt users to log into the system 600 to review their status on-line. Each element of a particular business process or transaction is broken down into process sub-elements based upon how the process operates in a live environment, and each sub-element of the process is then identified as a separate tracking and notification step. For example, for job applicants, the system 600 tracks and reports the following sub-elements of the hiring process: application status (i.e., withdrawn, complete, incomplete); applicant status points, vacancy information; and reminders and notifications.

FIG. 6 also shows the POM module 615. The POM module 615 provides a central performance feed back hub that provides significant capabilities to define, address, initiate, give feedback about, track assess and roll-up performance information. The POM module 615 facilitates the flow-down of strategic organizational goals to organizational units that then cascade into individual position performance objectives. The POM module 615 also tracks specific project milestones and assigned performance feedback dates. It automatically initiates and solicits employee feedback to collect information from an employee regarding how performance objectives are being met.

The POM module 615 also tracks overall organizational performance by “rolling-up” achievements from individual performance ratings into a consolidated organizational view. The POM module 615 provides for electronic performance appraisal whereby appraisals are tracked and, where necessary, performance deficiencies are evaluated and improvement plans generated by the module provide employees with specific skill- and knowledge-building activities and training to bring performance levels to full proficiency. The POM modules 615 also provides managers with a “gap analysis” which allows them to see, prior to the appraisal discussion, where their perceptions of employee performance may appear different from that of the employee.

The ELM module 620 provides a full range of support in the employee development area. It provides a comprehensive, enterprise class, learning management system covering all aspects of e-learning, classic training, developmental activities, competency assessments, career ladder development, promotion readiness, management development, classroom logistics management, instructor logistics management and training effectiveness assessment. For employees, the ELM module provides a self-service function that allows them to self-nominate for training opportunities, examine developmental activities appropriate to their position, career interests, career ladder, and track and monitor their own progress as they develop competencies key to their positions as well as competencies core to the organization's overall needs.

For managers, the ELM module 620 provides global tracking of their workforce's skill sets and development needs. Managers can see employee requests, initiate and approve employee nominations, track the progress of employees, view employees promotion and advancement readiness and correlate development activities to job performance. For staffing professionals, the ELM module 620 provides the following functionalities: enrollment support, classroom and course support services, financial support, an educational portal, training needs and effectiveness assessment, course development, instructor information and metrics and scheduling and hardcopy and forms generation and data transfers.

FIG. 6 also shows the Employee and Labor Relations (ERL) module 625. The ERL module 625 provides functionality relating to various employee and labor relations issues, including compensation administration, labor agreements and grievance management, as well as other dispute resolution techniques. The EEO module 630 provides functionality relating to civil rights laws, affirmative action requirements, workforce diversity issues and discrimination prevention methodologies. The Injury Compensation module 635 provides specialized views and access for management officials, medical personnel employees and claims processors. It provides data associated with various employee injury claims and the management of those claims.

FIG. 6 also shows the Salary and Position Management (SPM) module 640. The SPM module 640 provides guidance to managers about their budget, payroll expenditures, authorized positions, incumbency positions, likely near term budget scenarios and forecasted actions affecting salary and payroll. The SPM module 640 also depicts a manager's business unit in organizational chart form and helps to assess the unit against commonly accepted or desired organizational metrics.

The Succession Planning (SP) module 645 provides detailed information, by business unit, concerning the skills and capabilities represented by the employees within that unit, employees in the organization overall and job requirements as presented by the positions defined within the unit. This module allows line managers and staff professionals access to both top-level and specific information regarding current skills and the projection of skills needs in the future.

The Forecasting module 650 assists line managers and staff professionals in analysis, scenario planning and forecasting of organizations and their architecture and position design. This module provides low cost information of the current and projected organization. In addition, this module projects key events and their resulting impact on people, the organization's costs and the manager's overall plans. This includes projecting retirement, attrition, cycle time to fill positions, typical length of service and similar factors.

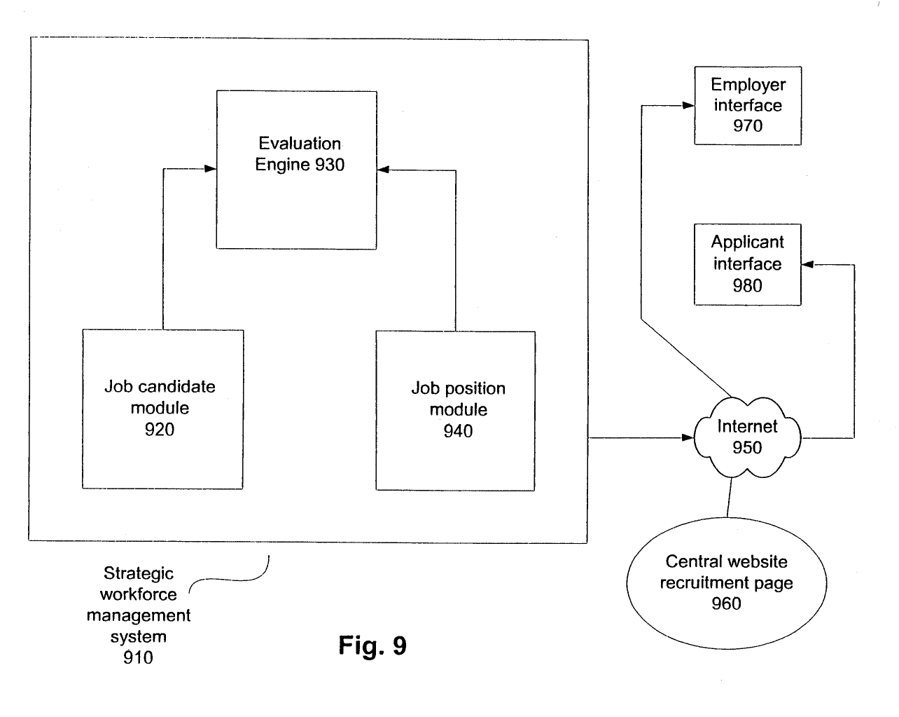

Returning to the classification functionality described above, FIG. 9 shows in greater detail classification of employment positions based upon an employer's input, and selection and presentation of qualified employment applicants to the employer based upon an evaluation rules engine. Thus, FIG. 9 shows the strategic workforce management system 910 coupled via a network connection, such as the internet 950, to an employer interface 970 and an applicant interface 980. An employer may access the strategic workforce management system 910 via the employer interface 970, such as a computer, in order to build a job position classification or to view a list of qualified candidates. A job candidate can access the centralized website recruitment page 960 via the applicant interface 980 in order to view job openings and in order to apply for those openings.

The strategic workforce management system 910 includes a job candidate module 920 communicatively coupled to an evaluation engine 930. The strategic workforce management system 910 also includes a job position module 940 communicatively coupled to the evaluation engine 930. In accordance with one embodiment of the invention, the job candidate module 920 and the evaluation engine 930 may be considered components of the staffing module 930, while the job position module 940 may be considered a component of the position design module 910. The job candidate module 920 may include a job candidate profile database (not shown). The job candidate profile database may include a profile of all applicants for employment that is generated based upon applicant responses to the questionnaires that they are presented, along with any information from resumes or employment applications. Thus, the job candidate profile database is a comprehensive database of all employment applicants that includes each applicant's qualifications.

The job position module 940 may include a job position classification database (not shown). The job position classification database may store job position classifications, which may include a description of available positions, duties and responsibilities, along with required qualifications and experience. The job position classifications may also be posted on the centralized website recruitment page 960 and thus be accessible to individuals interested in viewing and applying for employment opportunities.

Returning to FIG. 9, the evaluation engine 930 may include a relational database for storing a number of key factors, which are accessible by both the job candidate profile database and the job position classification database. The key factors include knowledge statements, skills, abilities, work styles, education, academic performance, certification, personal information and/or languages, which make up basic qualifications for job applicants. In addition to the minimum qualification factors, the evaluation database may generate a questionnaire that is based upon a specific job position classification as well as the knowledge, skills and abilities that correlate with the specific job position classification. The questionnaire may reside in the evaluation engine 930, the job position profile module 940 or any other database in a distributed system that is capable of accessing the job position profile module 940. The evaluation engine 930 also may use a variety of techniques for scoring employment candidate responses as will be described in greater detail below.

In operation, an employer, using the employer interface 970, can build a job position classification using the job position module 940. The employer may use a variety of techniques for creating a job position classification, including selecting a job title, compensation level, education or employment history. Each of these criteria is associated with specific duties and responsibilities that the employer may select in order to further refine the job position classification. Alternatively, the employer may build a job position classification by directly selecting from the job position module 940, via interface 970, desired duties and responsibilities for a position. Therefore, by selecting the desired duties and responsibilities, the employer has created the job position classification. The job position classification may be posted on the job position module 960 or, alternatively, the central website recruitment page 960. As described earlier, it is important to note that these job positions classification, including their associated duties and responsibilities, may be based upon an organization's guidelines or, for example, the Federal government's statutory guidelines for position classification. For example, the classifications may follow the Federal government's “PATCO” classification system which refers to:

professional/administrative/technical/clerical/order.

A job applicant can access the job position module 940 using the applicant interface 980 in order to view available job openings. The job applicant can then apply for positions by indicating an interest in specific positions. The job applicant may also post a resume or other documentation of employment history onto the job candidate module 920. As will described in greater detail below, the job applicant may be presented with queries relating to basic qualifications for a job position, as well as a more detailed questionnaire. The applicant's responses to these queries are utilized by the evaluation engine 930 to determine whether the job candidate is qualified for the position.

Once the job classification has been built and there is at least one job candidate, the evaluation engine 930 may begin the process for determining whether there are any qualified candidates for a job position. In accordance with one embodiment of the invention, the evaluation engine 930 queries the job applicants regarding certain basic qualifications, such as education level, compensation and general work history. The evaluation engine 930 then determines whether the applicant meets the basic qualifications for the job position that he or she has applied for. In the Federal employment arena, the basic qualifications may be governed by the Office of Personnel Management (OPM) guidelines and may include a job title, pay plan, occupational series, grade and salary range. Thus, the evaluation engine 930 will evaluate the applicant based upon these factors. If the applicant fails to meet the basic qualifications, the evaluation engine will notify the applicant, via the applicant interface 980, that he or she is ineligible for the job position, but may apply for other openings.

If the applicant meets the basic qualifications, the evaluation engine 930 then determines whether the applicant meets certain advanced qualifications. This evaluation is based upon the duties and responsibilities stored in the job position module 940. The duties and responsibilities for a specific job position description correlate to KSA's that may be stored in the evaluation engine 930. As described above, KSA's refer to specific knowledge, skills and abilities that are desired for a specific job position. The KSA's may be based upon an organization's judgment as to those skills needed for a particular position. In the Federal employment arena, the KSA's may be based upon Federal guidelines and rulemaking that govern the skills required for a particular position. The KSA's may be regularly validated by the employers, responsible supervisors and managers or industry experts to ensure that they accurately reflect the desired knowledge, skills and abilities for a particular job classification. If necessary, the KSA's may also be revised as qualification requirements change over time.

The evaluation engine 930 generates a questionnaire for applicants based upon the KSA's associated with a specific job classification. The applicants may be presented with the questionnaire via the applicant interface 980 and asked to respond to each of the questions. It is important to note that at this stage, the questions are based upon the KSA's and are directed to specific job positions. Once an applicant has completed the questionnaire, the evaluation engine scores the applicant's responses. There are numerous methodologies for scoring the responses to the questionnaire. However, in accordance with one embodiment of the invention, each question in the questionnaire has four possible responses. In this embodiment, each response has a score of 1, 2, 3 or 4, where 4 is the most desirable response and 1 is the least desirable. This weighted scoring system may be developed by a human resources specialist who determines the ideal response for each query. The evaluation engine 930 then tallies an applicant's score.

The evaluation engine 930 then selects the qualified applicants based upon the questionnaire scores. The exact process for selecting the qualified applicants may vary depending upon an employer's desired criteria. For example, the evaluation engine 930 may be configured to select applicants that meet a minimum score. Alternatively, the evaluation engine 930 may be configured to select a certain percentage of applicants, for example, the top 10% of scores. In accordance with one embodiment of the invention, the evaluation engine 930 may select applicants having scores that are clustered together within a close range. Regardless of which scoring methodology is implemented, the strategic workforce management system 910 then presents the employer, via the employer interface 970, with a list of qualified job candidates. The employer may also be presented with additional information regarding the selected applicants, including resumes, completed employment applications and responses to the questionnaires.

The invention also allows employers to select special factors that alter the standard scoring methodology of the evaluation engine 930. Thus, the evaluation engine 930 may be configured to grant preferences to certain applicants based upon certain criteria. These preferences may be configured so that the applicants meeting a certain criteria receive a score that is adjusted upward, or are selected outright regardless of their score. For example, in the Federal employment arena, the evaluation engine may be configured so that veterans receive automatic selection or a score that is adjusted upward.

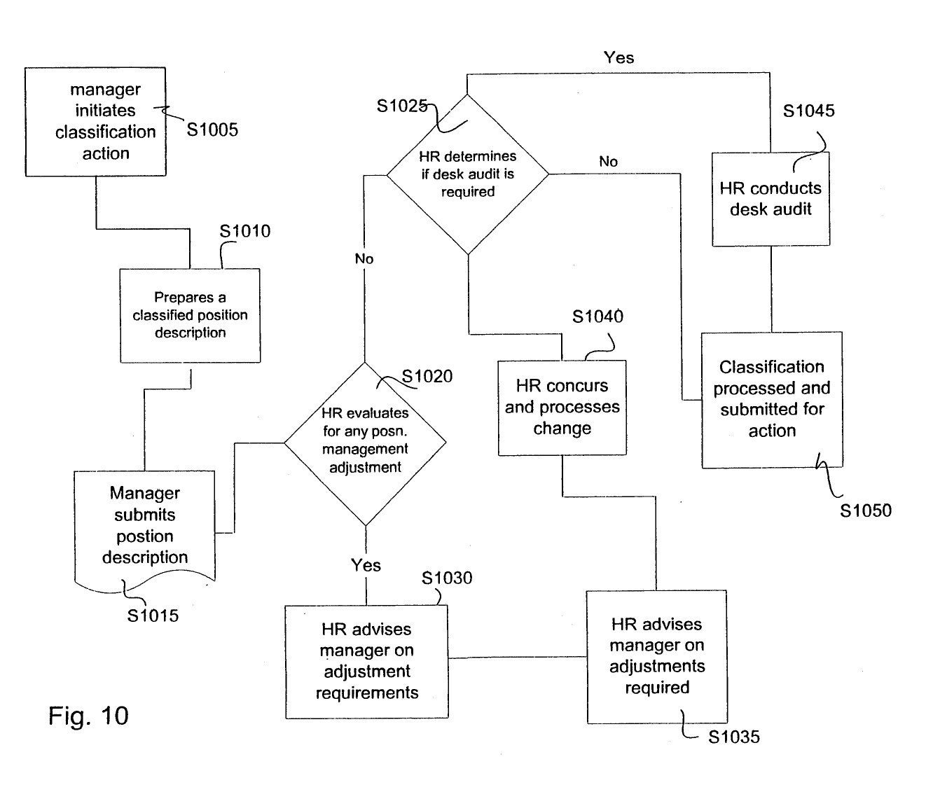

As described earlier, the job position classification may be constructed by a representative of a hiring organization. The process for building a job position classification in accordance with one embodiment of the invention is illustrated in FIG. 10. In FIG. 10, the process begins with step S1005. In step S1005, a manager first initiates a classification action in order to begin building a job classification for an available employment position. The process then moves to step S1010

In step S1010, a user prepares a classified position description for each job opening. It is important to note that the user may base the position description upon an organization's accepted guidelines for classifying positions. In the Federal employment arena, these description may be based upon Federal statutory guidelines. The process then moves to step S1015. In step S1015, the user submits the description of the position and the process then moves to step S1020.

In step S1020, the position description is evaluated to determine whether any adjustment is necessary. In one embodiment, this evaluation may be conducted by an organization's human resource (HR) personnel. It may, for example, be conducted by a supervisor, manager or other industry expert having experience with the organization's classification system. If in step S1020, an adjustment to the position description is required, the process moves to step S1030. Otherwise the process moves to step S1025.

In step S1030, recommendations for improving the position description are received from, for example, human resources personnel. The process then moves to step S1035. In step S1035, the necessary adjustments are carried out by, for example, human resources personnel. The process then moves to step 1040. In step S1040, the job description is changed in accordance with the adjustment determination of step S1035.

In step S1025, the system determines whether a desk audit is required. If a desk audit is not required, the process moves to step S1050. If a desk audit is required, the process moves to step S1045. In step S1045, a desk audit is conducted by human resources personnel. The process then moves to step S1050.

In step S1050, the classification action is processed and the job position description is submitted as the job position classification. At this time, the job position classification is built.

In developing the job position classification, there are many criteria in addition to the qualifications and educational criteria described above. For example, the employer may include relationships between duties, job classifications, compensation levels, performance issues, employee development activities, training and recruitment and staffing criteria and basic key factors such as knowledge statements, skills, abilities, work styles, education, academic performance, certification, personal information and languages. The criteria and key factors can determine the minimum qualifications and advanced qualifications required of employment applicants.

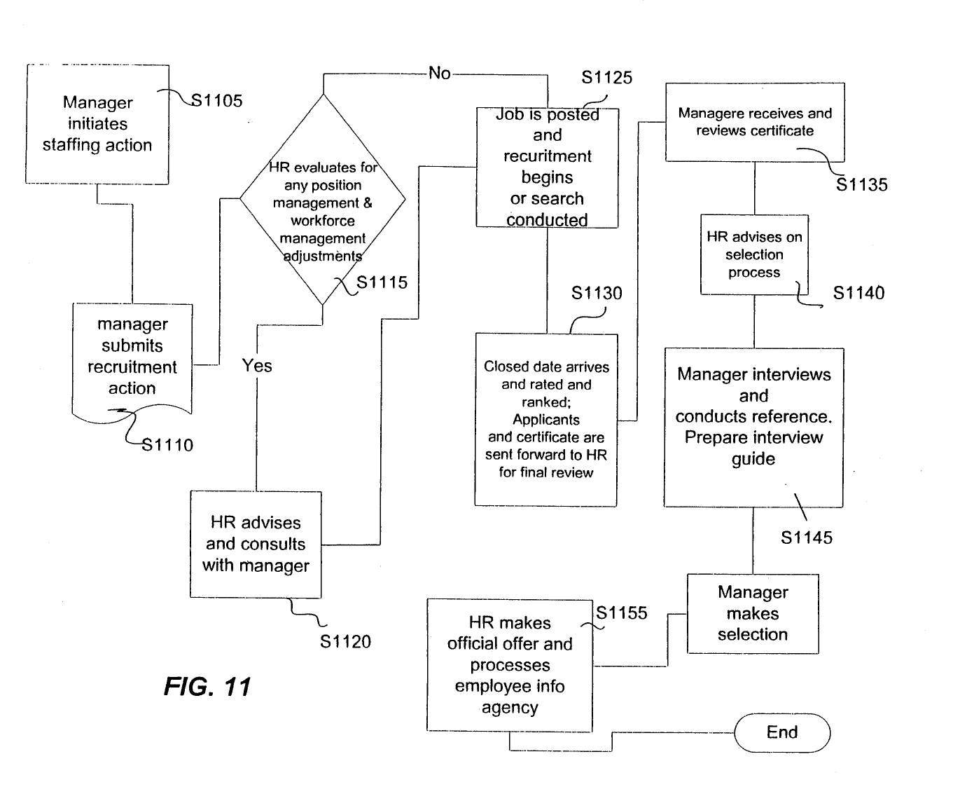

FIG. 11 illustrates in greater detail a process for carrying out the recruitment or staffing of new employees in accordance with an embodiment of the invention. In FIG. 11, the process begins in step S1105 where a representative of the hiring organizations, such as a manager, initiates a staffing action based upon a need for increased staffing. The process then moves to step S1110.

In step S1110, the manager submits a recruitment action, which is essentially a request for additional staffing. The process then moves to step S1115. In step S1115, after receiving the submission from the manager, the request is studied by, for example, human resources personnel to determine if any adjustments are needed. If no adjustments are needed, the process moves to step S1125. Otherwise, the process moves to step S1120. In step S1120, the human resource personnel consult and advise the manager in order to modify the position description and the process moves to step S1125.

In step S1125, a job position profile is created and posted in accordance with the agreed upon description. The position remains “open” or able to accept applications from employment candidates for a pre-determined length of time. Once the “open” time period for receiving applications ceases, the process moves to step S1130. In step S1130, the applications for employment are reviewed and studied against the employment openings. As described above, the applications may include information from a resume, employment application or responses to a pre-generated questionnaire. As described above, the responses to the questionnaires may be ranked in relation to how closely match required qualifications for a position. This process was described earlier in greater detail in connection with the evaluation engine. Once the applicants have been ranked, a report is generated listing qualified applicants and the process then moves to step S1135.

In addition to the list of qualified candidates, in an alternative embodiment, in step S1130 the system may also output an evaluation statement, a vacancy announcement, a crediting plan, a performance plan and an interview guide, etc. which can be varied depending upon custom requests. In step S1135, the list of qualified candidates is sent to the manger for review. The process then moves to step S1140.

In step S1140, the human resource personnel may provide their recommendation on selection of suitable candidates based upon the output from the evaluation program. The process then moves to step S1145. In step S1145, the manager studies both the results of the evaluation program along with any recommendations from the human resources department. The manager can also interview candidates and consult any references at this stage. The process then moves to step S1150.

In step S1150, a candidate selection is made by someone within the organization and the process moves to step S1155. In step S1155, a formal offer for employment is extended to the selected applicant or applicants and the process proceeds to step S1160 and ends.

As described above, the workforce management system of the invention allows an organization to generate and update the job position profile, the recruitment action, the closing date of recruitment and other information so that the job recruitment process can be automatically carried out on the computer system without requiring analysis from project experts.

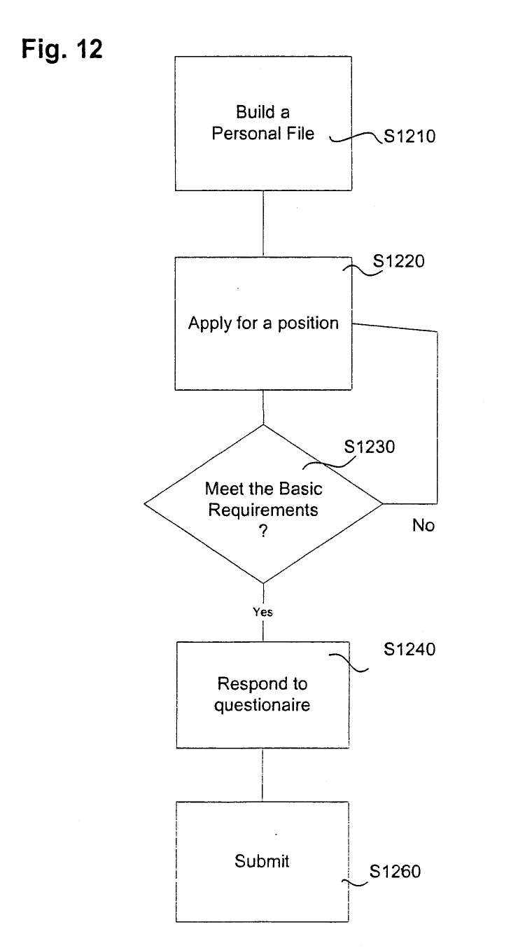

FIG. 12 illustrates the process for building a job applicant profile from the view point of a job applicant. FIG. 12 begins with step S1210 where an applicant for employment builds an employment profile. The applicant inputs information relating to education, work experience skills and other knowledge, such as foreign language ability. The applicant may also deliver a resume at this time. Upon completion, the process moves to step S1220. In step S1220, the applicant applies for a position by submitting his or her information and the process then moves to step S1230. In step S1230, the evaluation program determines whether the applicant meets certain minimum requirements. The minimum criteria, or basic qualifications, may be based upon varying employer requirements, as described earlier. If the applicant meets the basic qualifications, the process moves to step S1240. If the basic qualifications are not met, the process returns to step S1220 where the applicant may apply for a different position.

In step S1240, the applicant is presented with a detailed questionnaire that includes specific inquiries that relate to the position. The questionnaire is based upon the position that the applicant is applying for. As described earlier, the questionnaire may be based upon the KSA's associated with a particular employment position. The process then moves to step S1250. In step S1250, the applicant submits the completed questionnaire. As described earlier, the applicant's responses may be scored using the methodology selected by the particular employer. The process then ends from the applicant's standpoint.

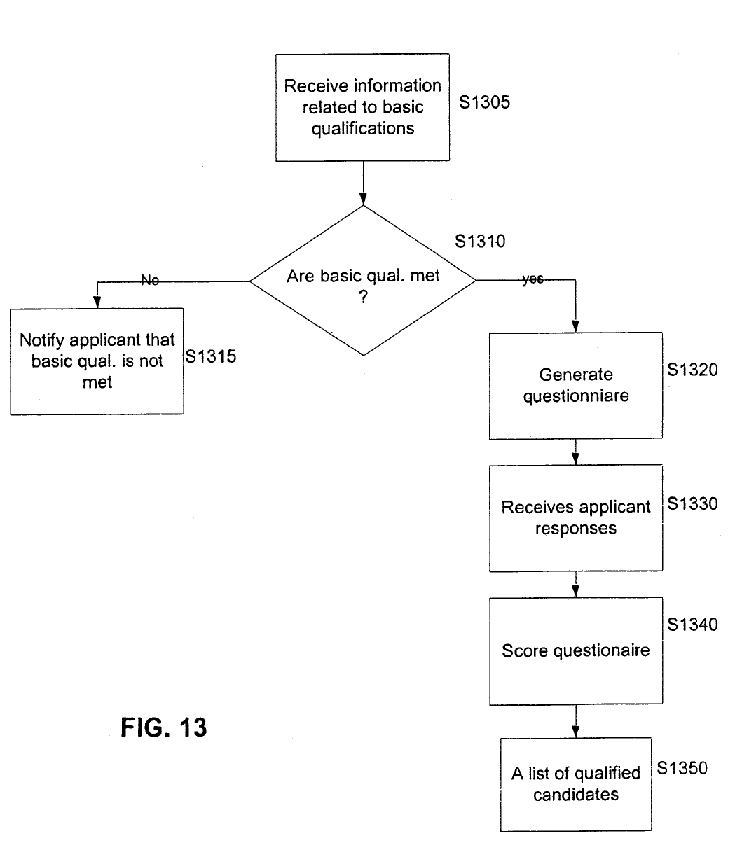

FIG. 13 illustrates a process for generating a list of qualified candidates in accordance with one embodiment of the invention. The process begins with step S1305 where the system receives an applicant's information relating to basic qualifications. The process then moves to step S1310. In step S1310, the system determines whether the applicant meets the basic qualifications based upon the applicant's input of step S1305. As described earlier, the basic qualifications may be based upon an organization's rules and guidelines for minimal requirements. In step S1310, if the system determines that the applicant does not meet the basic qualifications, the process moves to step S1315 where the applicant is notified and instructed to apply for a different position. If in step S1310, the system determines that the applicant does meet the basic qualification, the process moves to step S1320.

In step S1320, a the system generates a questionnaire that queries the user the regarding advanced qualifications. As described earlier, the questionnaire may be based upon the KSA's associated with a specific job position. The KSA's may in turn correlate with a specific organization's guidelines, i.e., the Federal government's classification system. The process then moves to step S1330 where the system receives the applicant's responses to the questionnaire. The process then moves to step S1340.

In step S1340, the applicant's responses to the questionnaire are scored. As described above the scoring system may vary depending upon the employer's requirements and may include built in preferences for certain candidates. The process then moves to step S1350. In step S1350, the employer receives a list of qualified applicants based upon the employer's own criteria. The system may also deliver relevant documentation about the selected applicants. The process then ends.

While the present invention has been particularly shown and described with reference to a preferred embodiment thereof, it will be understood by those skilled in the art that various other changes in the form and details may be made without departing from the spirit and scope of the invention.

What is claimed is:

1. A method for providing engineered workforce management content in a computer-based environment, comprising the steps of:
examining a plurality of workforce content sources and current operating business processes of an organization;
arranging information gathered from the examining step into a plurality of clusters in a computer database;
performing a multi-purpose workforce job analysis with a computer using the information arranged into the computer database to create engineered workforce content for management of human resources tasks;
providing at least one communications-centric hub for access to the engineered workforce content; and
executing programs on the at least one communications-centric hub to take user-supplied information and at least one of provide the user with additional related content, complete a transaction and provide notifications to other of a need to engage in workforce management in response to the user-supplied information,
wherein the step of examining includes conducting at least one of on-site monitoring, examination of content sources, desk audits with employees in an operating environment, examination of current operating business processes, interviews with subject matter experts, focus groups with subject matter experts and electronic vetting of content with subject matter experts.

2. The method according to claim 1, further comprising the steps of:
conducting a data entry task; and
merging data entered by the conducting step into a database.

3. The method according to claim 1, wherein the step of arranging information into a plurality of clusters includes the step of examining the operating environment of various organizations in which a body of content is used to determine how content can be organized for viewing by a user.

4. The method according to claim 1, wherein the step of performing multi-purpose job analysis includes the steps of
determining relationships between data;
defining markers and pointers between data; and
documenting the data and corresponding relationships.

5. The method according to claim 2, wherein the data entry step further comprises the steps of:
entering relationships between data;
entering markers and pointers between the data; and
converting the content to an interim database format.

6. The method according to claim 1, further comprising the steps of conducting continuous validation of data relationships and automatically re-calibrating data upon adjustment of any process.

7. The method according to claim 1, wherein the engineered content is accessed by a strategic workforce management system.

8. A strategic workforce management system, comprising:
a position management, recruitment and staffing module;
a performance optimization module;
an enterprise learning management module; and
at least one communications-centric hub for access to the modules.

9. The strategic workforce management module according to claim 8, further comprising:
an employee and labor relations' module;
an EEO module; and
an injury compensation module.

10. The strategic workforce management module according to claim 9, further comprising:
a salary and position management module;
a succession planning module; and
a forecasting module.

11. The strategic workforce management system according to claim 8, wherein the decisioning is conducted by at least one of a job evaluation and position classification rules engine, a candidate evaluation questionnaire generation rules engine, a candidate evaluation and referral list generation rules engine and a strategic plan integration into performance assessment rules engine.

12. The strategic workforce management system according to claim 8, wherein the position management, recruitment and staffing module supports at least one of position management, recruitment and staffing functionality.

13. A method for managing employment recruitment on a computer system, comprising the steps of
building at least one position classification;
creating at least one applicant profile;
evaluating the at least one applicant profile based upon the at least one job position classification; and
outputting at least one qualified job candidate based upon the result of the evaluating step.

14. The method according to claim 13, wherein the step of building the at least one position classification includes the step of determining a relationship between at least one of duties, job classifications, compensation levels, performance issues, employee development activities, training and recruitment and staffing criteria.

15. The method according to claim 13, wherein the step of building the at least one position classification includes selecting at least one of duties/responsibilities, a job title, a pay plan, and a grade.

16. The method according to claim 15, wherein the job title, pay plan and grade each include at least one associated duty/responsibility.

17. The method according to claim 13, wherein the position classification and duties/responsibilities are based upon Federal government statutory guidelines.

18. The method according to claim 13, wherein the position classification is one of a professional, an administrative, a technical, and a clerical classification.

19. The method according to claim 13, wherein the step of creating an applicant profile includes receiving applicant information that includes at least one of a resume, a job application or a statement of qualifications.

20. The method according to claim 13, wherein the step of evaluating includes:
determining whether an applicant meets basic qualifications;
generating a questionnaire for submission to applicant;
scoring the applicant's responses to the questionnaire; and
determining whether the applicant meets advanced qualification based upon the scoring step.

21. The method according to claim 20, wherein the basic qualifications are based upon Federal Office of Personnel Management guidelines.

22. The method according to claim 20, wherein the questionnaire is based upon knowledge, skills and abilities that correlate to a specific employment position.

23. The method according to claim 22, wherein the knowledge, skills and abilities are based upon Federal government guidelines for an associated position classification.

24. The method according to claim 23, wherein the questionnaire includes a plurality of questions and each question has four possible responses.

25. The method according to claim 24, wherein the each possible response has a weighted score.

26. The method according to claim 25, wherein the scoring step includes adding the weighted scores for each of the questions.

27. The method according to claim 26, wherein the at least one qualified job candidate is selected based results of the scoring step.

28. The method according to claim 13, wherein the step of building the position classification comprises the steps of:
analyzing job positions to obtain key documentation for each job position;
determining at least one relationship between the key documentation; and
classifying the job positions based on at least one determined relationships.

29. The method according to claim 28, wherein the key documentations includes at least one of job duties; compensation levels, performance issues, employee development activities, and recruitment and staffing criteria.
